(19) United States
(12) Patent Application Publication
(10) Pub. No.: US 2009/0085488 A1
(43) Pub. Date: Apr. 2, 2009

(54) BACKLIGHT FOR ELECTRONIC DEVICES

(75) Inventors: Jason D. Bridges, Lenexa, KS (US); Curtis E. Tabb, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD.

(21) Appl. No.: 11/865,544

(22) Filed: Oct. 1, 2007

(51) Int. Cl. G02F 1/13357; H05B 41/36

(52) U.S. Cl. 315/189; 349/69

(57) ABSTRACT

Techniques are described to enhance a backlight design for electronic devices. A circuit is described to provide backlight for a display of an electronic device. In an implementation, the circuit includes a collection of light elements arranged electrically in a series and includes one said light element of the series which is operable both with the collection and independently of the collection. In another implementation, the one said light element is arranged to be in a last position of the series electrically and physically is arranged to correspond to a center portion of the display of the electronic device.

### BACKGROUND

Backlights may be used to light displays which are provided with a variety of electronic devices. Such devices may be used indoors or outdoors, and in a wide range of ambient lighting conditions. Thus, users may seek devices which have a wide range of achievable brightness for the display to correspond to the range of ambient lighting conditions. Further, many available electronic devices are portablelbattery operated devices and users continually seek long battery life for these devices to prolong their enjoyment.

However, traditional backlights may not operate efficiently (e.g., have acceptable power consumption) over a wide range of light output. For example, a traditional backlight designed to achieve high display brightness may operate efficiently (e.g., relatively low power consumption) at high light output, but may become inefficient (e.g., relatively high power consumption) when operated to provide a lower amount of light output, such as in low-light conditions. Thus, traditional backlights may not be well suited to use in low-light conditions.

### SUMMARY

Techniques are described to enhance a backlight design for electronic devices. A circuit is described to provide backlight for a display of an electronic device. In an implementation, the circuit includes a collection of light elements arranged electrically in a series. One of the light elements of the series is operable both with the collection and independently of the collection.

In another implementation, the light element is arranged in a last position of the series electrically and physically is arranged to correspond to a center portion of the display of the electronic device.

In a further implementation, techniques are describe to operate a backlight circuit in a first mode to light a display using a collection of light emitting diodes (LEDS) of the backlight circuit. Operation may be switched to a second mode of the backlight circuit to light the display using one said LED of the collection, which may be positioned last in an electrical sequence of the collection of LEDs and physically in a central position relative to the display

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an exemplary electronic device in which an enhanced backlight design may be employed.

FIG. 2 depicts an exemplary implementation of a backlight circuit which may be employed by the electronic device of FIG. 1 as well as other devices.

FIG. 3 depicts an exemplary position-determining device having an enhanced backlight design in accordance with described techniques.

FIG. 4 depicts a diagram to illustrate exemplary selection of an optimum switching point between modes of an enhanced backlight.

FIG. 5 is flow diagram depicting an exemplary procedure to switch between multiple modes of an enhanced backlight.

### DETAILED DESCRIPTION

Traditional backlights may not operate efficiently (e.g., acceptable power consumption) over a wide range of light output. For example, a traditional backlight which is designed to achieve relatively high display brightness may operate efficiently (e.g., relatively lower power consumption) at high light output, but may become inefficient (e.g., relatively high power consumption) when operated to provide a lower amount of light output. Thus, traditional backlights may not be well suited for use in low-light conditions and have a limited range of achievable light output (e.g., brightness for a display).

Accordingly, techniques are described to enhance a backlight for an electronic device. A backlight circuit is described that provides backlight for a display of an electronic device. In an implementation, the backlight circuit includes a collection of light elements arranged electrically in a series and includes one light element of the series which is operable both with the collection and independently of the collection. Thus, when the backlight is operated with high light output (e.g., high brightness), the entire collection may be used. When, the backlight is operated in low light conditions (e.g., relatively low brightness), then the one light element of the series may be used independently.

In another implementation, the light element is arranged in a last position of the series electrically and arranged physically to correspond to a center portion of the display of the electronic device. For example, one light emitting diode (LED) of a collection of LEDs in a backlight that lights a corresponding rectangular display may be last in an electrical series relative to a power driver for the series. In the design, the one LED may be arranged within the collection to optically light a center of display (e.g., a center of the rectangle).

In a further implementation, techniques are described to operate a backlight circuit in a first mode to light a display using a collection of light emitting diodes (LEDS) of the backlight circuit. Operation may also be switched to a second mode of the backlight circuit to light the display using a single LED of the collection. The single LED may be positioned last in an electrical sequence of the collection of LEDs and physically in a central position relative to the display as previously described. Further, the mode switch may be configured to occur at a point that is calculated to be generally optimal, such as where light output of the series of LEDs approaches light output of the single LED.

In the following discussion, exemplary devices are first described that may be incorporate techniques to enhance a backlight design for a display of the device. Exemplary procedures are then described which may employed with the exemplary devices, as well as in other devices without departing from the spirit and scope thereof.

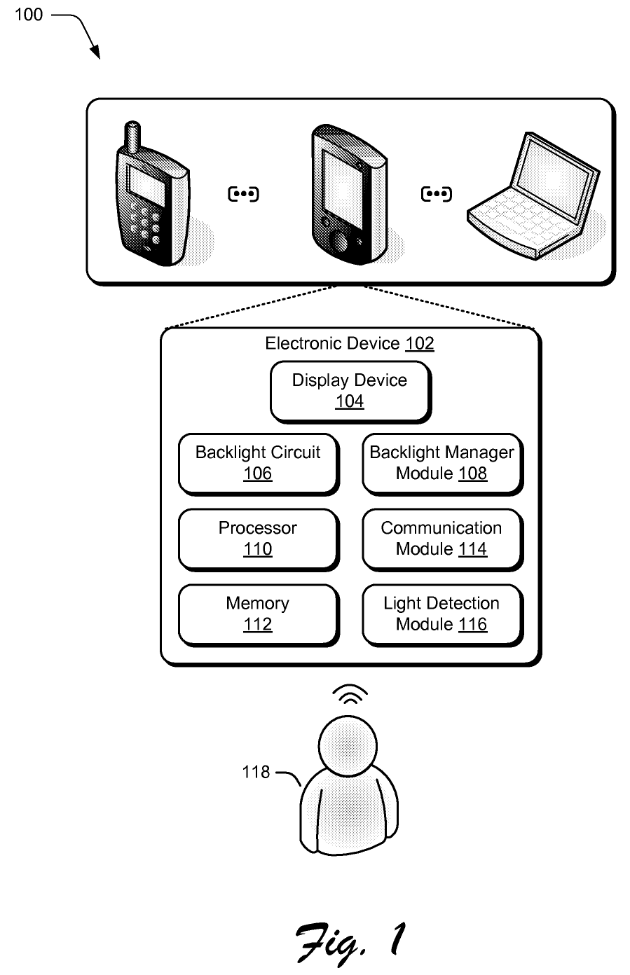

FIG. 1 illustrates an implementation 100 of an exemplary electronic device 102 in accordance with techniques to enhance a backlight design described herein. In the depicted example, electronic device 102 includes a display device 104, such as an LCD or other suitable display. Electronic device 102 further includes a backlight circuit 106 and a backlight manager module 108 which represents a variety of functionality to control operation of the backlight circuit 106.

Electronic device 102 may be configured in a variety of ways. For instance, electronic device 102 maybe configured as a device including, but not limited to, a position-determining device, a mobile phone, a gaming appliance, an audio player, a portable computer, a monitor, a calculator, television, a personal digital assistant, a video player, and/or a multimedia device. Generally, the techniques to enhance a backlight design for electronic devices described herein may be employed to reduce power consumption (e.g., improve battery life) and provide a wider and/or finer range of backlight operation. Thus, the described techniques may be particularly suited to battery operated devices which are used in a range of ambient lighting conditions, such as GPS devices, portable phones, hand held computing devices, portable media players and so forth. However, it is also contemplated that the described techniques may be advantageously used with wired power and less portable devices (e.g., televisions; devices for installation in a vehicle such as a GPS or video player; desktop monitors, and so forth) to reduce power consumption and provide a wider and/or finer brightness range.

In accordance with the principles described herein, backlight circuit 106 may include at least one light emitting element which is operable both independently and with a collection of light emitting elements to provide backlight to the display device 104 over a wide range of light output (e.g., brightness of the display device 104).

It should be noted, that for the purpose of providing a tangible example for the benefit of the reader, light emitting diodes (LEDs) are described in portions herein as an example of light emitting elements. However it should be understood by those of skill in the art that a variety of light emitting elements may be employed with the described techniques without departing from the sprit and scope thereof. Light emitting elements may include, but are not limited to, LEDs, incandescent bulbs, fluorescent elements, and other light emitting elements suitable for a backlight design of an electronic device 102.

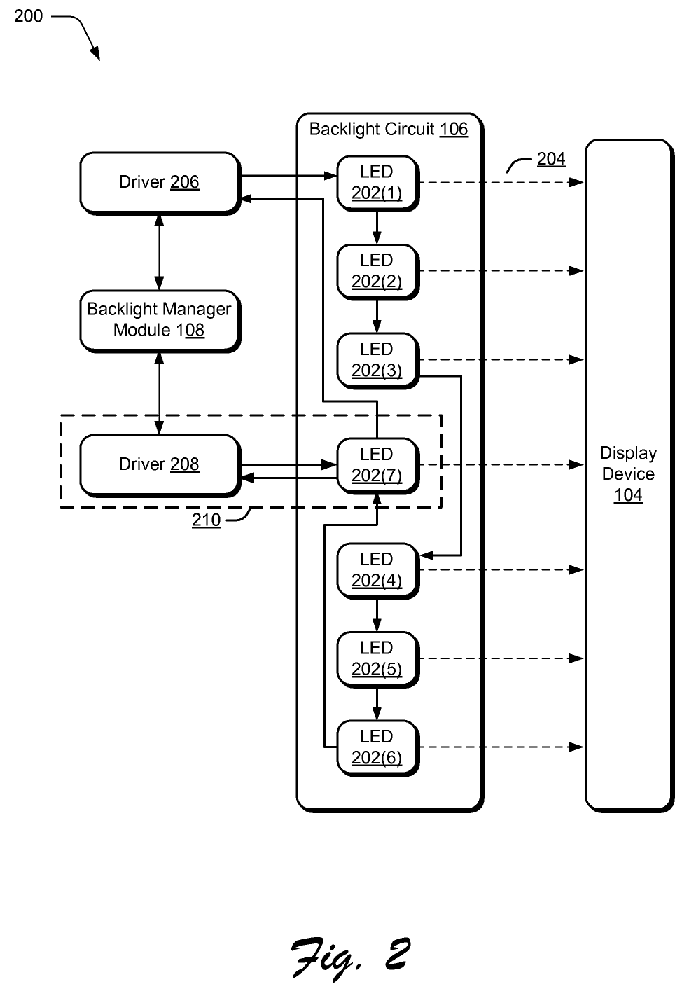

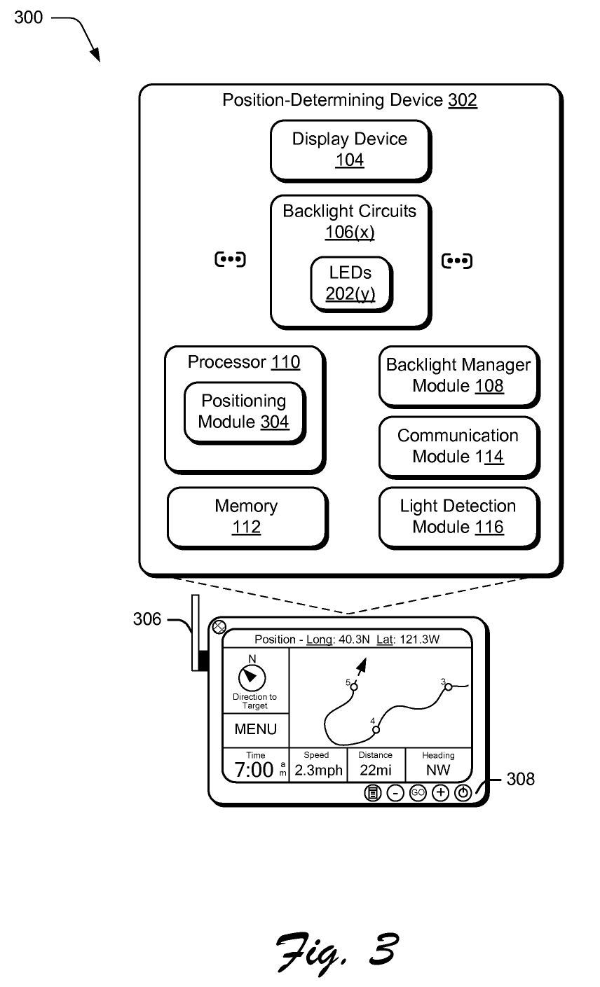

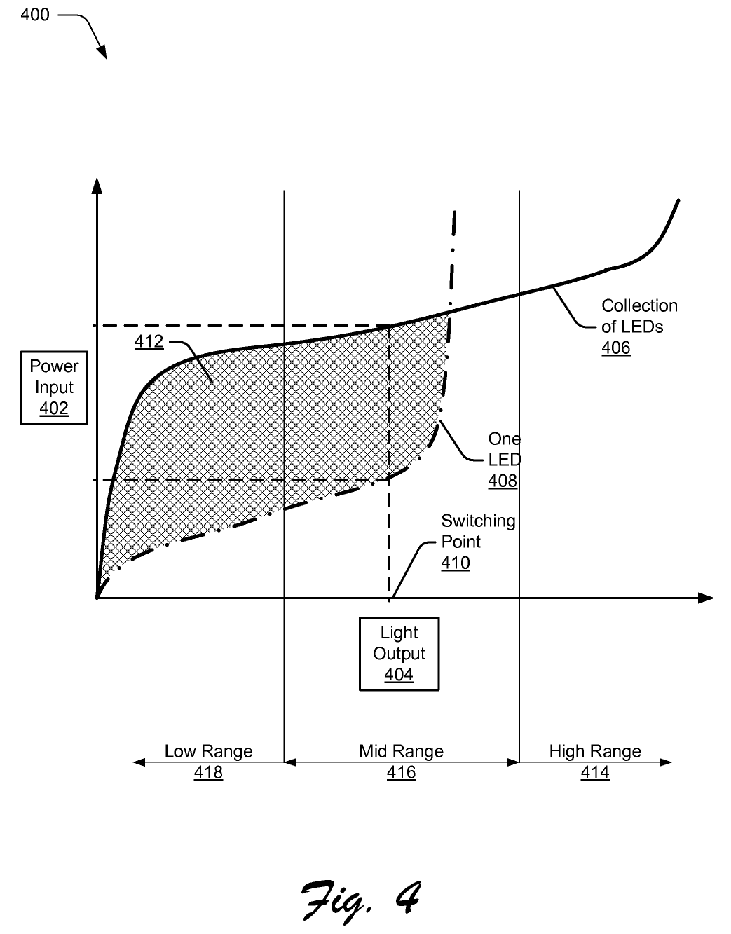

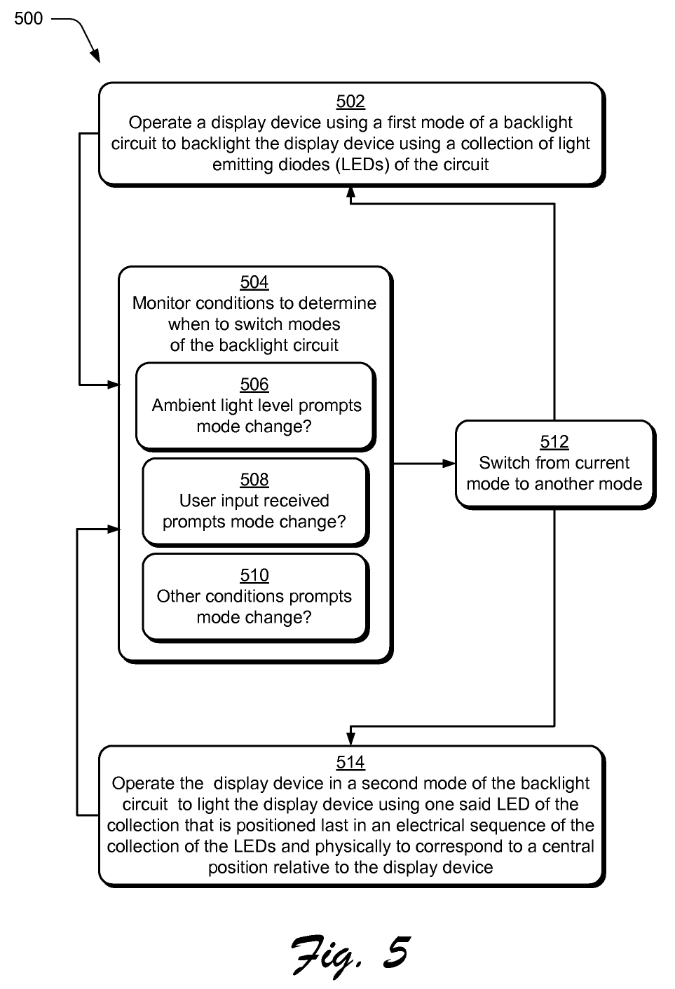

For example, backlight circuit 106 may be configured with a collection of light emitting diodes (LEDs) which are arranged electrically in a series. One of the LEDs of the series may be configured to operate both with the collection and independently of the collection. Thus, backlight circuit 106 may be operated in a first mode in which the collection of light emitting diodes (LEDs) is used to backlight the display device 104. Backlight circuit 106 may also be operated in a second mode in which a single LED of the collection of light emitting diodes (LEDs) is used to backlight the display device 104. Backlight manager module 108 may operate to manage switching between the modes. Further discussion of exemplary arrangements of a backlight circuit 106 may be found in relation to FIGS. 2-3. Further discussion of exemplary techniques to switch between different modes of a backlight circuit 106 may be found in relation to FIGS. 4-5.

In an embodiment, electronic device 102 may include a processor 110 and a memory 112 which may be utilized to provide a variety of processing and storage capabilities for the electronic device 102. For instance, backlight manager module 108 may be implemented as software which is executable on the processor 110 and also storable in the memory 112. Naturally, backlight manager module 108 may alternatively be implemented as a hardware component of the electronic device 102 or as a combination of hardware/software.

A variety of other application modules (not shown) may also be included to provide functionality to the electronic device 102. Application modules may include, but are not limited to, an operating system, drivers, desktop applications, device specific applications, and so forth. For example, an electronic device 102 configured as an audio player may include an application module to manage and playback a digital music collection which may be maintained in memory 112. In another example, an electronic device 102 configured as a mobile phone may include an application module to maintain a contact database and provide automatic/voice dialing features. A variety of other examples are also contemplated. The variety of applications modules may be implemented in hardware, as software which is storable in memory 112 and executable on processor 110, or combinations thereof.

The processor 110 is not limited by the materials from which it is formed or the processing mechanisms employed therein, and as such, may be implemented via semiconductor(s) and/or transistors (e.g., electronic integrated circuits (ICs)), and so forth. Additionally, although a single memory 112 is shown, a wide variety of types and combinations of memory may be employed, such as random access memory (RAM), hard disk memory, removable medium memory (e.g., the memory 112 may be implemented via a slot that accepts a removable memory cartridge), and other types of computer-readable media.

FIG. 1 further depicts a communication module 114 which may be provided with the electronic device 102. Communication module 114 is representative of communication functionality to permit an electronic device 102 to send/receive data between different devices (e.g., components/peripherals) and/or over a network. Communication module 114 may be configured in a variety of ways to provide the communication functionality including, but not limited to, having: one or more antennas; a transmitter and/or receiver; data ports; software interfaces and drivers; networking interfaces; data processing components; and so forth.

For example, communication module 114 for an electronic device 102 configured as a mobile phone may incorporate hardware and/or software to send/receive voice data over a cellular network. Likewise, a hand held computing device may include hardware and/or software to communicate via a wireless network according to one or more wireless protocols such as Institute of Electrical and Electronics Engineers, Inc. (IEEE) 802.11 standards, Bluetooth wireless specifications promulgated by Bluetooth Special Interest Group (SIG), Inc., and other suitable wireless standards. Wired connections, such as via USB, Ethernet, serial ports, and so forth are also contemplated. A variety of other examples are also contemplated, such as having hardware and/or software to send, receive and/or process global positioning satellite (GPS) data, email, instant messages, text messages, broadcast content, internet or other network packets, and so forth. Thus, communication module 114 may represent a variety of different communication functions which may be provided either individually or in combinations with an electronic device 102.

A light detection module 116 is also depicted, which represent functionality to detect and/or determine an ambient light level. For example, ambient light level may be detected via a light sensor that is provided with the electronic device 102. Additionally or alternatively, light detection module 116 may be configured to determine a ambient light level based on various data, such as positioning data received via the communication module 114, a time of day, a zip code, location data, a date, and combinations thereof. In an implementation, backlight manager module 108 may be configured to operate backlight circuit 106 based on an ambient light level that is detected or determined by the light detection module 116. In this manner, backlighting of the display device 104 may be adjusted automatically and without user intervention, based upon the ambient light level.

FIG. 1 also depicts a user 118 as interacting with the electronic device 102. The user 118 may interact with a electronic device 102 in a variety of ways, such as to view and interact with user interfaces and data output via the display device 104; interact with multimedia, Internet, and/or network content; send/receive various communications; and so on. In an implementation, backlight manager module 108 may be configured to operate backlight circuit 106 responsive to inputs from the user 118. For instance, the user 118 may manipulate the electronic device 102 through one or more controls to manually adjust the brightness of the display device 104. A variety of other interactions of a user 118 with an electronic device 102 are also contemplated.

Generally, any of the functions described herein can be implemented using software, firmware, hardware (e.g., fixed logic circuitry), manual processing, or a combination of these implementations. The terms “module” and “functionality” as used herein generally represent software, firmware, hardware or a combination thereof. In the case of a software implementation, for instance, the module represents executable instructions that perform specified tasks when executed on a processor, such as the processor 110 of the electronic device 102 of FIG. 1. The program code can be stored in one or more computer readable media, an example of which is the memory 112 of the electronic device 102 of FIG. 1.

FIG. 2 depicts an exemplary implementation 200 of a backlight circuit 106 which may be employed by the electronic device 102 of FIG. 1 as well as other devices. In the illustrated implementation, the backlight circuit 106 is depicted as including a collection of seven light emitting diodes (LEDs) 202(1)-202(7). Naturally, the number of LEDs which may be employed in a backlight circuit 106 using the described techniques may vary and is not intended to be limited to the depicted example of seven LEDs. The collection of LEDS 202(1)-202(7) is arranged to provide backlight 204 to the display device 104, as represented by the arrows between the collection of LEDS 202(1)-202(7) and the display device 104. An electronic device 102 as in shown FIG. 1 may include a plurality of backlight circuits 106 that are configured in accordance with the described techniques, further discussion of which may be found in relation to FIG. 3.

The collection of LEDS 202(1)-202(7) of FIG. 2 are depicted as being arranged electrically in a series. A driver 206 is also illustrated which may be configured to drive the electrical series. The driver 206 represents power input, circuitry, control functions, and/or logic that is operable to cause the collection of LEDS 202(1)-202(7) to provide backlight 204 to the display device 104. In an implementation, driver 206 may be configured to provide power input in the range of between about twenty volts to about ten volts.

At least one LED, for example LED 202(7) of FIG. 2, may be arranged to operate both with the collection (e.g., collection of LEDS 202(1)-202(7)) and independently of the collection. For instance, FIG. 2 depicts another driver 208 which may be provided to operate LED 202(7) independently of the LEDS 202(1)-202(6). Driver 208 represents power input, circuitry, control functions, and/or logic which is operable to cause the LED 202(7) to provide backlight 204 to the display 104 independently of the LEDS 202(1)-202(6). In an implementation, driver 208 may be configured to provide power input of about three volts and less.

Driver 208 and LED 202(7) are depicted as forming a circuit 210 which may be operated separately from operation of the collection of LEDS 202(1)-202(7) via the driver 206. The circuit 210 may be isolated when driver 206 is being used to power the collection of LEDS 202(1)-202(7). A variety of switching functionality (e.g., switches, program modules, logic, connections, and other hardware/software) may be employed to operate the circuit 210 and to permit LED 202(7) to be operated both as a member of the collection of LEDS 202(1)-202(7) and independently of the collection.

More particularly, the backlight manager module 108 may execute to selectively switch operation of the backlight circuit 106 between providing backlight 204 via the collection of LEDs 202(1)-202(7) and via the independent LED 202(7). Further, driver 206 may be a relatively high power driver (e.g., high voltage) compared to driver 208 which is relatively low power driver (e.g., low voltage). Thus, in general, power consumption may be lower in operation of the driver 208 compared with operation of driver 206. This may be particularly true when low backlight output is used (e.g., in low ambient light conditions) where the driver 206 may be inefficient in operating the collection of LEDS 202(1)-202(7) to provide the low backlight output.

One technique to permit an LED to be used both with a collection of LEDs and independently of the collection is to outfit an LED to be used independently with additional connections. For example, LED 202(7) in FIG. 2 may be outfitted with additional connections which may be used to form the depicted circuit 210. In an implementation, the additional connections are configured as an extra pin or pins on a connector for LED 202(7). The extra pin or pins may for instance be used to add an additional anode connection to the LED. Thus, LED 202(7) may be configured with multiple electrical connections that allow LED 202(7) to be electrically driven by both the driver 206 and the driver 208. Switching functionality as noted previously may then be employed to switch between different modes of operation of the backlight circuit 106. When the LED 202(7) is used independently, the driver 206 may be turned off. When the entire collection of LEDs 202(1)-202(7) is used, the circuit 210 may be isolated and the driver 208 may be turned off.

Thus, selective operation of the backlight circuit 106, via backlight manager module 108 or equivalent functionality, may result in efficiency gains, reduced power consumption, and longer battery life for an electronic device 102. Further, the operational range of a backlight circuit 106 may be extended to permit a wider range of backlight 204 outputs (e.g., display brightness) and to achieve a finer range (e.g., finer adjustability of brightness and smooth transitions throughout the operational range). Further discussion of techniques to selectively operate backlight circuit 106 may found in relation to FIGS. 4-5.

It is noted that the collection of LEDS 202(1)-202(7) in the example of FIG. 2 are arranged electrically in a series beginning from LED 202(1) and proceeding in numeric order to LED 202(7). Thus, the LED 202(7) in the example of FIG. 2 is arranged to be last in the series electrically. In an implementation, the physical arrangement (e.g., the physical sequence) of the collection of LEDs 202(1)-202(7) is different than electrical arrangement (e.g., the electrical sequence). For example, the LED 202(7) which is configured to operate independently and is arranged last in the series electrically, may be positioned in a central position physically within the collection of LEDS 202(1)-202(7).

For example, the LED 202(7) is arranged physically in FIG. 2 to optically light the center area of the corresponding display device 104. Thus, the electrical sequence is 1,2,3,4,5,6,7 relative to the driver 206 which powers the collection of LEDs while the physical sequence of the LEDS 202(1)-202(7) is 1,2,3,7,4,5,6. Physical sequence may be considered relative to physical dimension of the display 104, such as across the height and/or width. Naturally, this example is provided to illustrate aspects of the inventive principles and is not intended to limit the arrangement of a backlight circuit 106 to the enumerated sequences.

The positioning of a independently operable LED 202(7) in a central position within a collection of LEDs 202(1)-202(7) facilitates consistent and even distribution of backlight 204 to the display device 104 when the LED 202(7) is used independently. A central position as used herein may correspond to a physical dimension of the display device 104 and/or to a center portion of the display device 104 which receives the backlight 204. For example, in a linear arrangement of LEDs in a backlight circuit 106, a central position for a LED may correspond substantially to a centered along the width and/or height of the display device 104. In an arrangement of LEDs in a backlight circuit 106 which is an array (e.g., multiple columns and/or rows), the independently operated LED may be centered horizontally and vertically in the array.

For example, when the display device 104 is shaped generally as a rectangle, then a LED arranged in a central position physically may substantially correspond to a midpoint along the width and/or height of the rectangle. In another example, when the display device 104 is shaped generally as circle, then an LED arranged in a central position may be positioned to substantially correspond to a center of the circle. A variety of other examples are also contemplated.

For many electronic devices 102, a backlight circuit 106 will be employed to provide consistent and evenly distributed backlight 204. Accordingly, an independently operable LED 202(7) may be arranged to provide backlight 204 to a center portion of display device 104 as in the example of FIG. 2. However, it is contemplated that LED 202(7) may be positioned in other locations to provide backlight 204 to a specific and/or designated area of a display device 104. The specific and/or designated area may or may not correspond to a center portion of the display device 104.

For example, rather than being in a central position, LED 202(7) may be positioned to correspond to a designated area, such as the lower right hand portion of display device 104. When the LED 202(7) is used independently of the series, the backlight 204 will be directed to the lower right hand portion. This type of non-central arrangement might be used in certain applications to achieve particular backlight 204 characteristics or when the importance of evenly distributed backlight 204 is relatively low. A variety of other examples are also contemplated.

It should also be noted that, while LED 202(7) is depicted in FIG. 2 as being electrically part of the series, it is contemplated that LED 202(7) may configured to be electrically separate from the series. In this case, LED 202(7) may still be arranged as part of the collection of LEDs 202(1)-202(7) physically. However, the LED 202(7) may be electrically separate and independent. In other words, LED 202(7) may be operable individually via the driver 208 and circuit 210 (either alone or at the same time as the series), but may not be included in the electrical series with LEDS 202(1)-202(6). Thus, LED 202(7) in an implementation may not be operable via the driver 206 which operates the series. Such an arrangement might be used to simplify the electrical design of the backlight circuit 106 while still achieving efficiency gains in low-light operations. In this instance, backlight manager module may manage backlight circuit 106 such that: in one mode both of the drivers 206, 208 are used to drive the electrical series having LEDS 202(1)-202(6) and the single LED 202(7) respectively; and in a second mode, the driver 208 is used to operate the single LED 202(7) while the driver 206 and the electrical series having LEDS 202(1)-202(6) may be turned off.

FIG. 3 depicts an exemplary implementation 300 of an electronic device configured as a position-determining device. In the depicted example, electronic device 102 of FIG. 1 is configured as a position-determining device 302. Position-determining device 302 includes a positioning module 304 which is executable on a processor 110 and is also storable in memory 112. Positioning module 304 is representative of a variety of position-determining functionality which may be provided by the position-determining device 302.

Position-determining functionality, for purposes of this discussion, may relate to a variety of different navigation techniques and other techniques that may be supported by “knowing” one or more positions. For instance, position-determining functionality may be employed to provide location information, timing information, speed information, and a variety of other position-related data. Accordingly, the position-determining device 302 may be configured in a variety of ways to perform a wide variety of functions. For example, the positioning-determining device 302 may be configured for: hiking and other outdoor navigation activities as illustrated; vehicle navigation; aerial navigation (e.g., for airplanes, helicopters); marine navigation, personal use (e.g., as a part of fitness-related equipment); and so forth. Accordingly, the position-determining device 302 may include a variety of components to determine position using a variety of techniques.

The illustrated position-determining device 302 of FIG. 3 further includes an antenna 306 that may be communicatively coupled to communication module 114 which, as noted in the discussion of FIG. 1, may be configured to provide a variety of communication functionality. For example, communication module 114 may incorporate a receiver coupled to the antenna 306 to receive a variety of position data from one or more global positioning satellites, a retransmitting station, an aircraft, and/or any other type of positioning-system-enabled transmission device or system. The position data may then be processed via the positioning module 304 to perform position-determining functionality and output determined position results. Positioning-determining device 302 may further include one or more input devices 308 (e.g., a touch screen, control knobs and/or buttons, a microphone, a wireless input device, directional inputs, and so on). A user 118 may manipulate the one or more input devices 308 to provide various inputs to control operation of position-determining device 302.

Position-determining device 302 is further illustrated as including a plurality of backlight circuits represented as backlight circuits 106(x), where “x” may be any integer from two to “X”. Each of the plurality of backlight circuits 106(x) includes two or more LEDs 202(y) respectively, where “y” may be any integer from two to “Y”. Further, each of the plurality of backlight circuits 106(x) may be configured in accordance with the exemplary backlight circuit 106 described with respect to FIGS. 1-2.

For the purposes of example, consider a display device 104 configured generally as a rectangle. The plurality of backlight circuits 106(x) may include three exemplary backlight circuits 106 as discussed with respect to FIG. 2. The three backlight circuits 106(x) may be arranged in three linear rows across the width of the display device 104, in essence forming a grid of LEDs to backlight the display device 104. In this example, three independently operable LEDs (such as the LED 202(7) of FIG. 2) are provided, each corresponding to one of the three backlight circuits 106(x). The three independently operable LEDs may be arranged in a column along a line that corresponds to the midpoint of the width rectangle. The independently operable LED in the middle row of the three linear rows may correspond substantially to the center of the rectangle.

Using this type of arrangement of a plurality of backlight circuits 106(x), a variety of modes of operation may be employed to produce a wide operational range of backlighting. In one mode of operation, all three of the plurality of backlight circuits 106(x) may be used to provide high intensity backlight (e.g., high brightness). In another mode, a single one of the three backlight circuits 106(x) (e.g., a single one of the row) may be used without the other ones. Thus, the plurality of backlight circuits 106(x) may be operated at the same time or independently via a single driver (such as driver 206 of FIG. 2) or using multiple drivers.

In a further mode, the three independently operable LEDs (e.g., operable independent of the row of LEDs in which they are arranged) may be operated together to achieve low intensity backlight. In yet another mode, the independently operable LED which corresponds substantially to the center of the rectangle may be operated alone to achieve relatively very low intensity backlight. Thus, the three independently operable LEDs may be operated at the same time or independently via a single driver (such as driver 208) or using multiple drivers. A variety of other arrangements of one backlight circuit 106 or a plurality of backlight circuits 106(x) used in combination are contemplated.

FIG. 4 depicts an exemplary diagram 400 to illustrate determination of an optimum switching point between modes of operation of a backlight circuit. As noted previously, a mode switch for a backlight circuit 106 may be calculated to occur at optimum point where light output of each mode is equivalent or nearly equivalent to provide a seamless transition between the modes. The exemplary diagram 400 of FIG. 4 shows power input 402 plotted against light output 404 for an exemplary backlight circuit 106. Representative curves 406, 408 are shown for operation of a collection of LEDs and an independently operable LED respectively. For the purposes of example, FIG. 4 is discussed in relation to the exemplary backlight circuit 106 of FIG. 2. Thus, in this example curve 406 may correspond to the collection LEDs 202(1)-202(7) and curve 408 to the single LED 202(7).

It is noted that the curves 406, 408 are provided to illustrate visually the determination of an optimum point at which modes may be switched. The curves 406, 408 do not necessarily correspond to actual values. Those of skill in the art will appreciate that these curves may vary widely for different arrangements of a backlight circuit 106 which may use different numbers of lighting elements, different drivers, and so forth. However, the principles of selecting an optimum point discussed with respect to FIG. 4 are applicable to many arrangements, including exemplary arrangements discussed with respect to FIG. 3 in which a plurality of backlight circuits 106(x) are employed.

When switching between operation of a collection of LEDs and a single LED there may be many considerations. For instance, a switching point may be selected such that the switch is transparent (e.g., non-observable) to the user 118 when viewing the display device 104. Further, the switching point may be selected to minimize power consumption over the light output 404 range. Still further, the capabilities (e.g., achievable light output; power drivers used; efficiencies; and so on) of the circuit 106 may also be considered.

Thus, determining an optimum switching point for the backlight circuit 106 of FIG. 2 may involve selecting a point where light output of the collection substantially matches the light output of the single LED, such that the switch is non-observable to a user 118. One such point in FIG. 4 is represented by the switching point 410.

However, as may also be seen in FIG. 4, there may be numerous points where light output is equivalent e.g., each light output 404 value corresponding to the hatched region 412 between the curves 406, 408. Thus, determining an optimum switching point may also involve determining which of the numerous light output values minimizes power consumption. Accordingly, the depicted switching point 410 may represent a point that has been determined to minimize power consumption. A variety of factors may affect where the selected switching point 410 occurs along the light output 404 scale, such as the shape of curves 406, 408, efficiency data, the capabilities of both the collection of LEDs and the single LED, and so forth.

FIG. 4 further shows logical ranges of light output operation including a high range 414, a mid range 416, and a low range 418. A single LED 202(7) will have an associated maximum achievable light output. This maximum may be less than light output in the high range 414. Thus, in the high range 414 the collection of LEDs 202(1)-202(7) is employed to provide high light output. The collection of LEDs 202(1)-202(7) generally consumes more power and becomes inefficient as light output is decreased. Thus, in the low range 418 the single LED 202(7) is employed.

Accordingly, the switching point 410 between various modes of circuit 106 may occur somewhere in the mid range 416 where power consumption is optimized. In an implementation, the switching point 410 is selected to occur as near as possible to the maximum achievable light output of the single LED 202(7). This point may approach the lowest achievable power consumption since generally the single LED 202(7) uses a lower power driver 208 than the driver 206 and consumes less power than the collection of LEDs 202(1)-202(7).

The following discussion describes techniques to operate an enhanced backlight circuit 106 that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the devices of FIGS. 1-3 and/or the diagram of FIG. 4. The features of techniques described below are platform-independent, meaning that the techniques may be implemented on a variety of commercial computing platforms having a variety of processors. FIG. 5 depicts a procedure 500 in an exemplary implementation in which the operation of a backlight circuit 106 is switched between various modes. For the purposes of clarity, FIG. 5 illustrates a procedure 500 for switching a backlight circuit 106 between two modes of operation. However, it is contemplated that analogous switching procedures may be employed to perform switching between two or more modes of a backlight circuit 106.

A display device is operated using a first mode of a backlight circuit to light the display device using a collection of light emitting diodes (LEDs) of the circuit (block 502). For the example, backlight manager module 108 may be executed to operate backlight circuit 106 of FIG. 2, such that the collection of LEDS 206(1)-202(7) provides backlight to the display device 104. In this mode, backlight manager module 108 may cause driver 206 to drive the collection of LEDS 206(1)-202(7).

One or more conditions are monitored to determine when to switch modes of the backlight circuit (block 504). For instance, while the backlight circuit 106 is being operated in one mode, backlight manager module 108 may monitor a variety of different conditions which may prompt a mode change. For example, ambient light level may be monitored (block 504), such as via a light detection module 116. As noted ambient light level may be determined directly by a light sensor or based on various data collected/stored at an electronic device, such as date, time, position data, and so forth. Thus a mode change may occur automatically and without user intervention, responsive to a detected or determined ambient light level.

In another example, user input is monitored (block 506), such as inputs provided by a user 118 through manual (e.g., “with hands”) manipulation of one or more input devices 308 (e.g., a touch screen, one or more buttons, and so on) to adjust the brightness of the display manually. Thus, a mode change may also occur responsive to user input.

A variety of other conditions (block 508) may also prompt a mode change. For example, other conditions may include, but are not limited to: remaining battery life; a change in the mode of power supply (e.g., from line power to battery power); a timer; an event such as a electronic device 102 entering or waking up from a “sleep” mode; an incoming communication; a preset or user configurable program; and so forth.

In the absence of one of the variety of conditions being determined in block 504 to cause a mode switch, the monitoring of the various conditions may continue. Naturally, monitoring may be interrupted by other events such as a user turning off the device; an alert message; a program interrupt; and/or execution of other instructions which stops execution of the monitoring to process data and/or accomplish other tasks.

When a condition to prompt a mode switch is determined in block 504, a switch is performed between modes (block 512), such as switching from a current mode to another mode of operation of a backlight circuit 106. The switch may be performed at a switching point 410 which has been determined in accordance with the principles discussed with respect to FIG. 4. Thus, the switch may be non-observable to a user 118 and configured to minimize power consumption for the backlight circuit 106 and an associated electronic device 102. Following the mode switch, the display device 104 is operated in the selected other mode of the backlight circuit.

For instance, a backlight circuit may be operated in a second mode of operation in which the display device is provided backlight using one said LED of the collection that is positioned last in an electrical sequence of the collection of the LEDs and physically to correspond to a central position relative to the display device (block 514). In the continuing example, backlight manager module 108 may be executed to operate backlight circuit 106 of FIG. 2 such that the independently operable LED 202(7) provides backlight to the display device 104. In this mode, backlight manager module 108 may cause driver 208 to drive the independently operable LED 202(7). Switching to a variety of other modes is also contemplated, such as switching between the plurality of modes discussed with respect to the position-determining device 302 of FIG. 3.

While backlight circuit 106 is operating in the second (e.g., other mode) of block 514, the procedure 500 may return to block 504 where conditions which may cause a mode switch are again monitored. When a condition to prompt a mode switch is determined in block 504, procedure 500 may return to block 512 where another mode switch may occur. The mode switch may be back to the first mode of block 502, to a different mode, and so forth. Thus, mode switches may occur in the described manner between two modes as illustrated in FIG. 5, or as the case may be, between three or more modes of a backlight circuit 106.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A device, comprising:
a display; and
a circuit to provide backlight for the display having a collection of light emitting diodes (LEDs) arranged electrically in a series and including one said LED which is operable both with the collection and independently of the collection.

2. The device as described in claim 1, wherein the one said led is arranged to be electrically in a last position of the collection of LEDs relative to power input from a driver to power the collection of LEDs.

3. The device as described in claim 1, further comprising:
a module to selectively switch between a first mode and a second mode of the circuit, the first mode using the collection of LEDs to light the display, and the second mode using the one said LED to light the display.

4. The device as described in claim 3, wherein the module is to switch between the first and the second mode based upon input from a user.

5. The device as described in claim 3, wherein the module is to:
determine a level of ambient light; and
switch between the first mode and the second mode without user intervention based upon the determined level of ambient light.

6. The device as described in claim 1, further comprising:
a first driver to power the collection of LEDs;
a second driver to power the one said LED; and
a module to selectively switch between a first mode and a second mode of the circuit, the first mode using the first driver to light the display with the collection of LEDs, and the second mode using the second driver to light the display with the one said LED.

7. The device as described in claim 1, wherein the switch occurs approximately at an equivalence point between a light output of the collection of LEDs and a light output of the one said LED, such that the switch is not observable to a viewer of the display.

8. The device as described in claim 1, wherein the one said LED is positioned physically in a central location relative to the display.

9. The device as described in claim 1, wherein:
the collection of LEDs is arranged substantially in an array corresponding to the display; and
a physical sequence of the collection of LEDs in the array is different than a electrical sequence of the collection of LEDs in the series.

10. The device as described in claim 1, wherein the one said LED is arranged in a last position electrically within the collection of LEDs and arranged physically with the collection of LEDs to correspond approximately to a midpoint of the display.

11. The device as described in claim 1, wherein the display is shaped substantially as a rectangle and the one said LED is positioned physically to approximately correspond to a center of the rectangle.

12. A backlight circuit, comprising:
a collection of light emitting elements to provide backlight to a liquid crystal display (LCD) in a first mode of the backlight circuit; and
a particular light emitting element operable independently of the collection of light emitting elements to provide backlight to the LCD in a second mode of the backlight circuit.

13. The backlight circuit as described in claim 12, wherein the particular light emitting element is a member of the collection of light emitting elements.

14. The backlight circuit as described in claim 13, wherein:
the collection of light emitting elements are arranged in an electrical sequence;
the particular light emitting element is arranged to be last in the electrical sequence; and
the particular light emitting element is arranged optically to light a center portion of the display.

15. The backlight circuit as described in claim 12, wherein at least one said light emitting element is a light emitting diode (LED).

16. The backlight circuit as described in claim 12, wherein the particular light emitting element is arranged optically to light a center portion of the LCD display.

17. The backlight circuit as described in claim 12, wherein the particular light emitting element operates with the collection of light emitting elements in the first mode.

18. A method comprising:
operating a backlight circuit in a first mode to light a display using a collection of light emitting diodes (LEDS); and
switching to a second mode of the backlight circuit to light the display using one said LED of the collection which is positioned last in an electrical sequence of the collection of LEDs and physically in a central position relative to the display.

19. The method as described in claim 18, further comprising monitoring to detect a condition to prompt said switching, the condition selected from a group consisting of:
user input;
a level ambient light level;
time of day; and
a condition based upon positioning data collected by a positioning device having the display.

20. The method as described in claim 18, wherein the central position is centered horizontally relative to the display.

21. The method as described in claim 18, wherein the central position is centered horizontally and vertically relative to the display.

22. A device, comprising:
a liquid crystal display (LCD);
a backlight to the LCD having a collection of light emitting diodes (LEDs) arranged electrically in a series and including one said LED that is operable both with the collection and independently of the collection; and
a module to selectively switch between a first mode and a second mode of the circuit, the first mode using the collection of LEDS to light the LCD, and the second mode using the one said LED to independently of the collection light the LCD.

23. A device as described in claim 22 further comprising functionality to determine position based on global positioning satellite (GPS) timing data obtained at the device.

24. A device as described in claim 22, further comprising:
a first driver to power the collection of LEDs; and
a second driver that is configured to provide a lower voltage than the first driver to power the one said LED when operated independently of the collection.

25. A device as described in claim 24, wherein the module is configured to selectively switch between a first mode and a second mode of the backlight at approximately a point where light output from the collection of LEDs powered by the first driver equals light output of the one said LED powered by the second driver.
